(19) United States
(12) Patent Application Publication
(10) Pub. No.: US 2011/0127891 A1
(43) Pub. Date: Jun. 2, 2011

(54) APPLIANCE AND LID ASSEMBLY

(76) Inventor: MATTHEW SIMON COSGROVE, DUNEDIN (NZ)

(21) Appl. No.: 12/954,174

(22) Filed: Nov. 24, 2010

Related U.S. Application Data
(60) Provisional application No. 61/264,571, filed on Nov. 25, 2009.

(51) Int. Cl. A47L 15/42; D06F 39/14; E05F 11/02

(52) U.S. Cl. 312/228; 49/324

(57) ABSTRACT

A washing appliance including a wash receptacle and a lid assembly for closing an open top of the wash receptacle. At least a peripheral portion of the lid assembly is movable toward and away from the open top of the wash receptacle between a sealed condition contacting contact portions of the periphery of the open top and an unsealed condition spaced away from the periphery of the open top. The lid assembly is generally rectangular and has front, rear and side portions. In the closed condition the peripheral portion of the lid assembly is urged against the top of the receptacle by forces applied to opposed side edge portions of the lid assembly. Front and rear portions of the contact portion of the receptacle periphery are planar and the peripheral portion of the lid structure is curved across front and rear contact portions, to be closer to the receptacle periphery in central portions of the front and rear contact portions than lateral portions of the front and rear contact portions.

### FILED OF INVENTION

The present invention relates to domestic appliances having a top-loading receptacle and a moving closure for closing the receptacle.

### SUMMARY OF PRIOR ART

Drawer-type washing appliances are known in which a tub or wash receptacle is mounted for movement between a closed position inside a cabinet and an open position outside the cabinet. A lid disposed inside the cabinet closes the top opening of the tub with the tub in the closed position. The lid stays in the cabinet when the tub moves to the open position.

A range of closures have been proposed in prior patent publications including U.S. Pat. Nos. 5,470,142, 6,189,551, 6,571,808, 7,152,612 and 7,422,022.

Commercially available products have used closures incorporating a free-moving lid which is drawn down onto the upper portion of the tub by actively controlled linear actuators or by arrangements driven by movement of the tub. In either case, the lid is pressed or pulled downwards from its lateral edges. A seal on the peripheral underside of the lid is compressed against a flange on the peripheral upperside of the tub.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

It is an object of the invention to provide a washing appliance which will at least provide the public a useful choice, or to provide a lid assembly for a washing appliance that at least goes some way to providing the industry with a useful choice.

In one aspect, the present invention may broadly be said to consist in a washing appliance comprising a wash receptacle and a lid assembly for closing an open top of the wash receptacle, at least a peripheral portion of the lid assembly is movable toward and away from the open top of the wash receptacle between a sealed condition contacting contact portions of the periphery of the open top and an unsealed condition spaced away from the periphery of the open top; the lid assembly being generally rectangular and having front, rear and side portions in the closed condition the peripheral portion of the lid assembly is urged against the top of the receptacle by forces applied to opposed side edge portions of the lid assembly, and wherein front and rear portions of the contact portion of the receptacle periphery are planar and the peripheral portion of the lid structure is curved across front and rear contact portions, to be closer to the receptacle periphery in central portions of the front and rear contact portions than lateral portions of the front and rear contact portions.

According to a further aspect, the curvature of the lid front and rear peripheries is greatest at the central portion and decreases toward the lateral portions.

According to a further aspect, the width of the lid assembly is greater than its front to back depth, and is greater than 800 mm.

According to a further aspect, the washing appliance is a domestic dishwasher.

According to a further aspect, the washing appliance includes a cabinet, and slide rails, the receptacle being movable into and out of the cabinet on the slide rails and the lid assembly being mounted in the cabinet.

According to a further aspect, the washing appliance includes an actuator mechanism supporting the lid assembly.

In a further aspect, the present invention may broadly be said to consist in a washing appliance comprising a wash receptacle and a lid assembly for closing an open top of the wash receptacle, at least a peripheral portion of the lid assembly is movable toward and away from the open top of the wash receptacle between a sealed condition contacting the periphery of the open top and an unsealed condition spaced away from the periphery of the open top; the closing forces applied to the lid, the shape and stiffness of the lid assembly, and the shape of the top periphery of the receptacle being such that when the peripheral portion of the lid is pressed against the receptacle into the sealing condition, the variation in sealing pressure across the width of the forward sealing portion of the lid is less than would be expected for a lid assembly of the same stiffness where the shape of the lid assembly and receptacle provide a uniform clearance across the width of the forward sealing region with the lid raised.

According to a further aspect, in the closed condition the peripheral portion of the lid assembly is urged against the top of the receptacle by forces applied to opposed sides of the lid assembly.

According to a further aspect, the compressive force is substantially uniform around the seal.

According to a further aspect, with the lid in the unsealed condition the separation between the peripheral portion of the lid structure and periphery of the receptacle varies across the width of the appliance, being greater at the lateral edges than at the central portion.

According to a further aspect, in the unsealed condition, the peripheral portion of the lid is less curved than in the sealed condition.

According to a further aspect, the peripheral portion of the receptacle is planar in the contact portion of the lid, and the peripheral portion of the lid structure is curved across the front and rear contact areas, to be closer to the receptacle periphery in the central portions than the lateral portions.

In a further aspect, the present invention may broadly be said to consist in a washing appliance comprising a wash receptacle and a lid assembly for closing an open top of the wash receptacle, the lid assembly having a front edge, a back edge and side edges, the front and back edges being longer than the side edges, at least a peripheral portion of the lid assembly is movable toward and away from the open top of the wash receptacle between a sealed condition contacting the periphery of the open top and an unsealed condition spaced away from the periphery of the open top; the closing forces applied to the lid, the shape and stiffness of the lid assembly, and the shape of the top periphery of the receptacle being such that when the peripheral portion of the lid assembly is urged against the top of the receptacle by forces applied to opposed sides of the lid assembly, the total sealing force along the front and back edge is greater than the total sealing force along the side edges.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The term “comprising” is used in the specification and claims, means “consisting at least in part of”. When interpreting a statement in this specification and claims that includes “comprising”, features other than that or those prefaced by the term may also be present. Related terms such as “comprise” and “comprises” are to be interpreted in the same manner.

### BRIEF DESCRIPTION OF THE DRAWINGS

FIG. 1 is a free body diagram of the lid according to a preferred embodiment of the present invention as it touches the tub flange. The curvature of the lid is exaggerated. The tub is represented in broken lines.

FIG. 2 is a free body diagram of the lid of FIG. 1 after it is compressed onto the tub flange.

FIG. 3 is a simplified cross-section of a drawer-style washing appliance incorporating the present invention.

FIG. 4 is an enlarged detail of a peripheral portion and a central portion, in partial cross-section, of the lid area of a washing appliance incorporating the present invention.

FIG. 5A is a free body diagram of a lid tub flange according to an alternate embodiment of the present invention as the lid touches the tub flange. The curvature of the tub flange is exaggerated. The tub is illustrated in broken lines.

FIG. 5B is a free body diagram of the lid of FIG. 5A with the lid compressed onto the tub flange.

### DETAILED DESCRIPTION

The present invention relates to washing appliances and in particular, to laundry washing machines or dishwashers. The most likely application of the present invention is in dishwashers where drawer style appliances have been gaining popularity. A significant area of attention in drawer style dishwashers is creating and maintaining a good seal for the wash receptacle during the wash cycle. For opening the appliance, the wash receptacle is withdrawn from the cabinet, such as on a slide rail. In this “open” condition, the items to wash can be loaded into or unloaded from the receptacle.

For washing, or periods of non-use, the receptacle is pushed back into a “closed” position inside the surrounding cabinet.

A common closure includes a lid permanently positioned in the cabinet (or surrounding structure) which is movable between an upper position in which it is generally above the level of the rim of the receptacle and a lower position in which it is pressed against the rim or lip of the receptacle.

A number of mechanisms have been proposed for moving the lid between the open and closed conditions. In some of these mechanisms, the actuation force is derived from movement of the receptacle between the open and closed positions. Other arrangements include an independently driven drive mechanism for pulling or pushing the lid against the rim of the wash receptacle.

Most commonly, these mechanisms act on the lateral edges of the lid assembly, so as not to consume space between the lid assembly and the upper inside surface of the cabinet. This helps maximise the depth of the wash receptacle relative to the overall height of the cabinet.

The present invention provides an improvement to the relative forms of the lid assembly and receptacle which may improve the sealing performance of the closure with limited effect on the cost of the lid structure and the space occupied by the lid assembly in the cabinet.

According to this improvement, the closing forces applied to the lid, the shape and stiffness of the lid assembly and the shape of the top periphery of the receptacle are such that when the peripheral portion of the lid is pressed toward the receptacle into the sealing condition, the variation in sealing pressure across the width of the front edge of the lid is less than would be expected for a lid assembly of the same stiffness, where the shape of the lid assembly and the receptacle provide a uniform clearance across the width of the receptacle with the lid raised.

In preferred forms, this is achieved by providing a profile of the front periphery of the lid assembly and the front lip of the receptacle which together, provide increasing clearance moving from the centre portion to the lateral portions. When the lid assembly is pulled downward or pressed downward from its lateral edges, the sealing pressure causes bending of the centre portion of the lid. The initial curvature of the lid assembly or receptacle is such that this bending created by the seal pressure leads to a substantially constant clearance between the lid and the receptacle lip in the closed condition. A seal, typically carried in the lid assembly, is present in between the lid and the peripheral lip of the receptacle. Most practically, this seal is formed with a substantially constant cross section. In that case, a substantially constant clearance corresponds with a substantially constant sealing pressure across the width of the front and rear portion of the receptacle.

Variations within the scope of the invention are possible. The seal of the lid assembly may have a varied cross section to achieve the same effect in conjunction with the relatively rigid structural parts of the lid assembly. However, the seal typically is a soft material most easily formed by extrusion to have a uniform cross section so this approach of having a varying thickness of seal is not preferred. As an alternative, a spacer of variable thickness could be provided between the underside of the lid and the back of the seal. Alternatively, the lid could be provided with a perimeter wall of varying height to which the seal is attached.

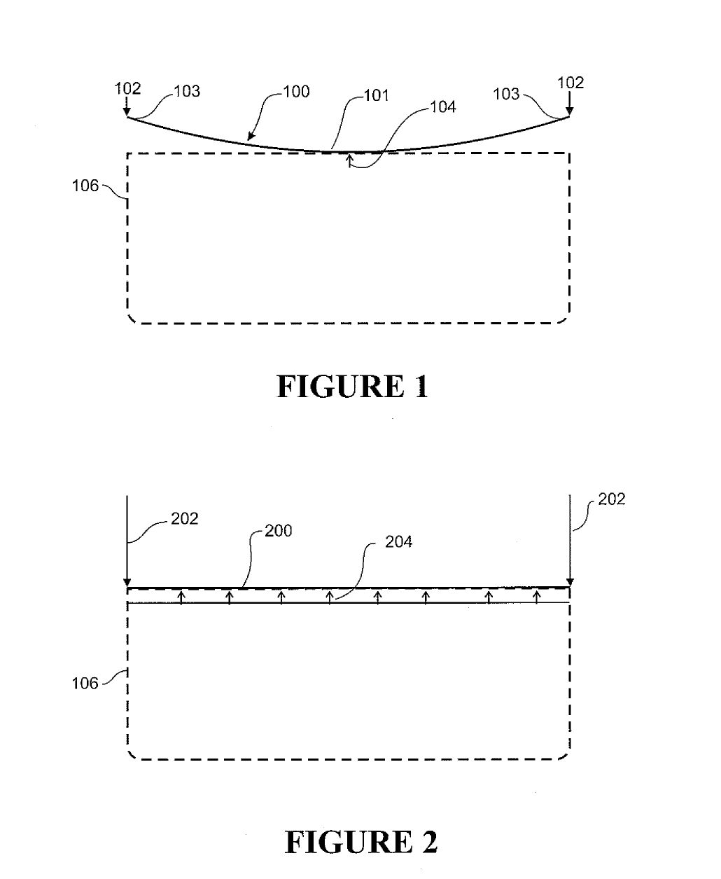

FIG. 1 is a free body diagram of the front portion of the lid assembly according to the most preferred embodiment of the present invention. The lid 100 includes a curve in at least the front portion. According to this curve, the central portion 101 is lower than the two lateral portions 103. In FIG. 1, the lid is shown as it just contacts the upper rim of the tub 106 (illustrated in broken lines) so that minimal forces 102 are being applied to the lateral edges of the lid with a minimal countering force 104 from the tub at the centre.

FIG. 2 is an equivalent free body diagram once the lid 200 has been pulled down onto the tub by the closing actuators. The closing actuators may provide a combined force of for example 200N. 25 to 30% of this closing force is intended to exert across the front portion of the seal. There is now a large force 202 at each lateral edge of the lid countered by a distributed upward force 204 from the seal along the edge of the tub. This distributed countering force produces a bending moment in the lid that rises progressively across the width of the lid from one edge to the centre, falling again from the centre to the far edge. This bending moment bends the lid in a direction opposite to the initial unloaded curvature of the lid so that, in this closed condition, the relevant parts of the lid are essentially planar and match the surface of the sealing lip of the tub.

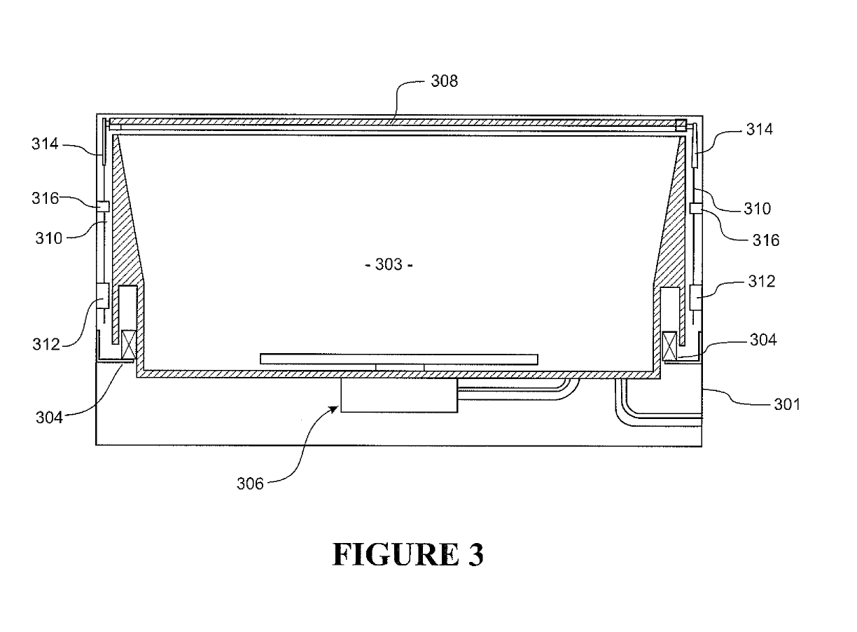

A simplified cross section of a drawer-style washing appliance incorporating the present invention is illustrated in FIG. 3. The appliance includes a cabinet 301 and a tub or wash receptacle 303. The tub or wash receptacle is movable into and out of the cabinet on slide rails 304 that connect between the lateral sides of the receptacle and the lateral sides of the cabinet. A wash system 306 is arranged in the lower portion of the tub 303. In the case of a conventional dishwasher, the wash system may include wash and drain pumps, one or more spray arms and a heater for the wash water. Other types of dishwasher wash system including direct spraying from fixed nozzles or by spray units mounted to the rear, front or the sides of the wash receptacle. The present invention can also be applied to, for example, laundry machines, in that case the interior of the wash receptacle may house a rotating wash drum having a horizontal rotating axis or a vertical rotating axis and associating machinery for driving the wash drum. A range of wash systems are known in the art for either type of appliance. The specific nature of the wash system does not form part of the present invention and will not be described in detail.

The cabinet 301 may be a completely enclosing structure, for example, with a sheet metal wrapper enclosing the top, bottom, left and right side, and back walls. Alternatively it may have one or more open walls or partially open walls. Alternatively the cabinet may be an open framework. Alternatively the cabinet may be built in place, as the cavity within which the appliance is secured. In that case, slide rails 304 would be directly secured to the interior surfaces of the custom cabinet work. Preferably the cabinet is a sheet metal structure or open framework. This provides for a complete, easy to mount unit which protects the integrity of the machine as it is installed.

Lid 308 is mounted in the upper portion of cabinet 301. With the tub 303 in the closed position the lid 308 is above the tub 303. In the illustrated embodiment, the lid 308 is supported by an actuator mechanism on each side. The illustrated actuator mechanism at each side includes a linear actuator 312, a lift rod 310 and a support yoke 314. The support yoke 314 preferably extends to join the lateral periphery of the lid along a significant portion of the depth of the lid. This yoke serves to reinforce these lateral edges of the lid and distribute the closing force along the depth dimension of the edge to reduce the adverse bending along a portion of the lid. That approach to reducing bending is possible along the sides of the lid in way which is not possible across the front portion of the lid where the drawer must be able to be withdrawn.

In preferred forms of the present invention, the curve of the lid is applied across both the front and rear peripheral portions. Alternatively, it might be applied in the same fashion along the whole depth of the lid so as to have a uniform, or substantially uniform shape in a transverse cross section. To reduce complexity, a similar curving profile is not made in the front to back direction of the lid.

The lift rods 310 of the actuator mechanism may include one or more linear bearing 316 attached to the cabinet.

This is one example actuator mechanism for lifting the lid during or prior to withdrawal of the tub and pressing the lid closed against the top of the tub during or after the return of the tub to the cabinet. A range of other mechanisms are described in the prior art which also act on the lateral peripheries of the lid. These include other forms of active control with actuators and mechanisms to transfer the force of the actuators to the lid. These also include passive mechanisms that translate closing and opening movements of the tub into closing and opening movements of the lid. These can involve the lid being biased to a closed condition (for example, by one or more springs or weights) and pushed open by a cam and surface arrangement as the tub is withdrawn. Alternatively, they can include the lid being biased to an open condition (for example by springs) and pressed into a closed condition via a cam and track arrangement on movement of the receptacle or tub to a closed condition. The cam and track or surface arrangement can act between the lid and the tub. Alternatively the cam arrangement can act between the lid and the cabinet, with a movement of the lid being made by a portion of the movement of the tub.

The lid 308 is illustrated as a generally flat closure. This could be as simple as a pressed metal or moulded plastic panel. Preferably there is a downwardly facing seal located around the periphery.

Additional lid improvements that are preferably used together with the present invention are described in PCT patent publication WO2008/150184. A preferred lid in accordance with that disclosure includes an outer frame portion and a centre portion supported within the outer frame portion by a flexible diaphragm. The outer frame portion includes a downwardly facing seal. The centre portion may be freely suspended by the diaphragm within the outer frame portion or may be connected with the cabinet.

In the preferred implementation, the outer frame and centre portion are moulded from a plastics material such as polypropylene. The seal and diaphragm are moulded from a comparatively soft and resilient material such as a thermoplastic elastomer. To increase the stiffness so that only a small curve in accordance with the present invention is required, one or more reinforcing ribs or braces may be provided across the width of the lid at the forward and rear portions. These may be integrated moulded reinforcing ribs or separate brace components, formed for example from sheet metal.

Sound absorbing material may be provided on the upper surface to reduce the noise transmitted from the lid by water impacting on the lower surface of the lid during washing.

The benefit of the initial curvature of the front portion of the lid is that when chosen correctly in conjunction with the stiffness of the lid assembly, it will provide a uniformly distributed compression on the seal when the lid is drawn down onto the top of the tub. This is especially important in a wide dishwasher where the front and rear sealing spans may be greater than 800 mm. An example of such a dishwasher is illustrated in US patent publication 2007/0186964. This initial curvature is a cost and space effective way to provide lid structure that is stiff enough to maintain its shape and provide the uniform load without the extra cost of trying to make a straight lid much stiffer.

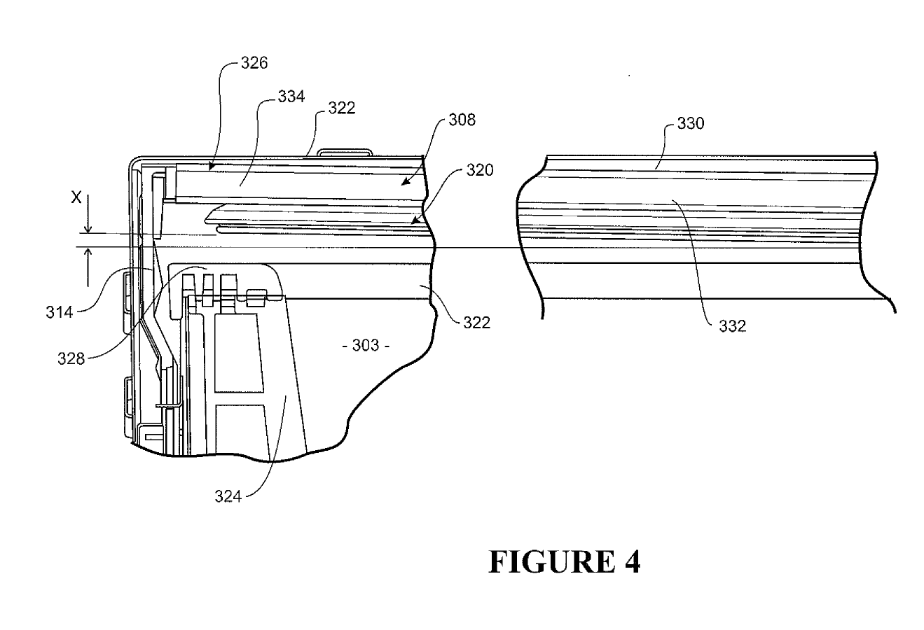

FIG. 4 is an enlarged cross sectional view of a lateral portion and a centre portion of the sealing region of the lid and tub. The lateral portion shows the lateral peripheral region 326 of the lid above a lateral region 328 of the sealing lip of tub 303. The actuator yoke 314 is connected with the side edge of lid 326. The centre portion 332 of the front periphery of the lid frame is lower than the lateral portion 334 of the front portion of the lid frame by an amount X. The amount X, and the variation in curvature across the width of the lid that results in amount X, depend on the stiffness of the lid and the intended total sealing force to be distributed across the width of the lid. There is also a desire to keep X small, as X contributes lower seal extremity at the centre portion of the lid which provides an extra constraint on the height of tub that can fit within a given height of cabinet. Ideally the curvature varies across the width of the seal region. The typical bending moment distribution will have a peak bending at the centre region falling away to the lateral regions. The preferred curvature at each location is a function of the bending moment and the local stiffness. According to the preferred function the curvature (defined as the increase of the radius of curvature “R”) is proportional to the bending moment (M) and invertly proportioned to the local stiffness (defined by the combination of material stiffness E and sectional modulus I). For single material profiles thus can be represented as

$$\frac{1}{R} = \frac{M}{EI} .$$

As an example, with the lid span of 825 mm and total closing force of 200 Nm applied at the edges, the stiffness of the forward peripheral portion of the lid may be around 137 Nm² and the total depth of curvature (X) may be about 4 mm.

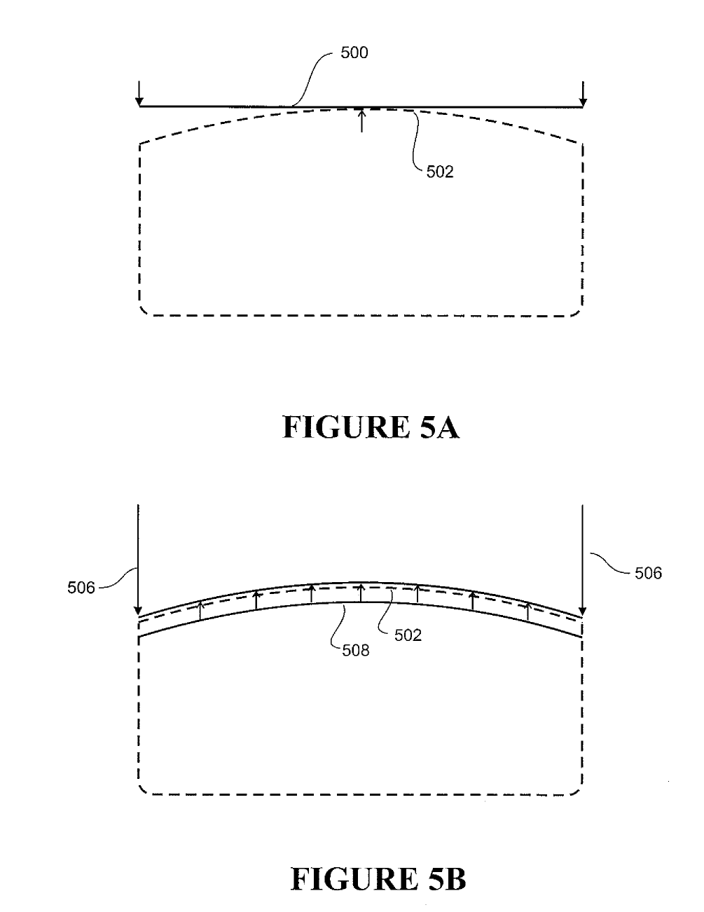

In FIG. 4, the lid is not shown in cross section and the centre portion 330 of the lid assembly can be seen protruding above the downwardly curved front periphery 332. Aspects of the construction of the tub are also illustrated in FIG. 4 where it can be seen that the tub includes a side wall 324 and a separate and moulded sealing lip or flange 322 secured to the upper edge of the side wall, for example, by ultrasonic welding. FIGS. 5a and 5b illustrate one of the possible ways of implementing the present invention where instead of providing a curve in the lid, a curve is provided in the front sealing portion of the tub.

FIG. 5a is a free body diagram showing the straight lid 500 just touching the upper curved edge 502 of the tub. FIG. 5b is a free body diagram illustrating the same lid when pulled into its fully sealed condition by sealing actuator forces 506. Distributed countering force 508 from the edge 502 bends the lid 500. Preferably the stiffness profile of the lid and curvature of the edge 502 are such that the intended sealing force 506 bends the lid to parallel the curved profile of the edge 502.

So according to the present invention, the stiffness profile across the width of the sealing portion of the lid, the varying clearance between the sealing portion of the lid and the sealing portion of the tub and the intended sealing force are selected so that in the sealed condition an even sealing force is provided across the front sealing region. This is particularly applicable to the front sealing region where the tub or receptacle is withdrawn through the front of the cabinet and the lid is constrained or actuated on at its lateral edges. Equivalent design can also be advantageously applied across the rear sealing region. While equivalent design could be applied along the side sealing regions so that the sides could be actuated at only a single, or few spaced locations, the side regions have less constraint as to form and can be more easily made rigid. This is also the case for the rear sealing region, which could, for example, be made more rigid by a downwardly extending flange that sits behind the wash tub with the wash tub in a closed condition.

1. A washing appliance comprises a wash receptacle and a lid assembly for dosing an open top of the wash receptacle,
at least a peripheral portion of the lid assembly is movable toward and away from the open top of the wash receptacle between a sealed condition contacting contact portions of the periphery of the open top and an unsealed condition spaced away from the periphery of the open top;
the lid assembly being generally rectangular and having front, rear and side portions in the closed condition the peripheral portion of the lid assembly is urged against the top of the receptacle by forces applied to opposed side edge portions of the lid assembly, and
wherein front and rear portions of the contact portion of the receptacle periphery are planar and the peripheral portion of the lid structure is curved across front and rear contact portions, to be closer to the receptacle periphery in central portions of the front and rear contact portions than lateral portions of the front and rear contact portions.

2. A washing appliance as claimed in claim 1 wherein the curvature of the lid front and rear peripheries is greatest at the central portion and decreases toward the lateral portions.

3. A washing appliance as claimed in claim 1 wherein the width of the lid assembly is greater than its front to back depth, and is greater than 800 mm.

4. A washing appliance as claimed in claim 1 that is a domestic dishwasher.

5. A washing appliance as claimed in claim 4 including a cabinet, and slide rails, the receptacle being movable into and out of the cabinet on the slide rails and the lid assembly being mounted in the cabinet.

6. A washing appliance as claimed in claim 5 including an actuator mechanism supporting the lid assembly.

7. A washing appliance comprises a wash receptacle and a lid assembly for closing an open top of the wash receptacle,
at least a peripheral portion of the lid assembly is movable toward and away from the open top of the wash receptacle between a sealed condition contacting the periphery of the open top and an unsealed condition spaced away from the periphery of the open top;
the closing forces applied to the lid, the shape and stiffness of the lid assembly, and the shape of the top periphery of the receptacle being such that when the peripheral portion of the lid is pressed against the receptacle into the sealing condition, the variation in sealing pressure across the width of the forward sealing portion of the lid is less than would be expected for a lid assembly of the same stiffness where the shape of the lid assembly and receptacle provide a uniform clearance across the width of the forward sealing region with the lid raised.

8. A washing appliance as claimed in claim 7 wherein in the closed condition the peripheral portion of the lid assembly is urged against the top of the receptacle by forces applied to opposed sides of the lid assembly.

9. A washing appliance as claimed in claim 7 wherein the compressive force is substantially uniform around the seal.

10. A washing appliance as claimed in claim 7 wherein with the lid in the unsealed condition the separation between the peripheral portion of the lid structure and periphery of the receptacle varies across the width of the appliance, being greater at the lateral edges than at the central portion.

11. A washing appliance as claimed in claim 10 wherein, in the unsealed condition, the peripheral portion of the lid is less curved than in the sealed condition.

12. A washing appliance as claimed in claim 10 wherein the peripheral portion of the receptacle is planar in the contact portion of the lid, and the peripheral portion of the lid structure is curved across the front and rear contact areas, to be closer to the receptacle periphery in the central portions than the lateral portions.

13. A washing appliance as claimed in claim 10 wherein the curvature of the lid front and rear peripheries is greatest at the central portion and decreases toward the lateral portions.

14. A washing appliance as claimed in claim 7 wherein the width of the lid assembly is greater than its front to back depth, and is greater than 800 mm.

15. A washing appliance as claimed in claim 7 that is a domestic dishwasher.

16. A washing appliance as claimed in claim 15 including a cabinet, and slide rails, the receptacle being movable into and out of the cabinet on the slide rails and the lid assembly being mounted in the cabinet.

17. A washing appliance as claimed in claim 16 including an actuator mechanism supporting the lid assembly.

18. A washing appliance comprising a wash receptacle and a lid assembly for closing an open top of the wash receptacle,
the lid assembly having a front edge, a back edge and side edges, the front and back edges being longer than the side edges, at least a peripheral portion of the lid assembly is movable toward and away from the open top of the wash receptacle between a sealed condition contacting the periphery of the open top and an unsealed condition spaced away from the periphery of the open top;
the closing forces applied to the lid, the shape and stiffness of the lid assembly, and the shape of the top periphery of the receptacle being such that when the peripheral portion of the lid assembly is urged against the top of the receptacle by forces applied to opposed sides of the lid assembly, the total sealing force along the front and back edge is greater than the total sealing force along the side edges.

19. A washing appliance as claimed in claim 18 wherein the width of the lid assembly is greater than its front to back depth, and is greater than 800 mm.

20. A washing appliance as claimed in claim 18 that is a domestic dishwasher.
